(19) United States
(12) Patent Application Publication
(10) Pub. No.: US 2003/0018892 A1
(43) Pub. Date: Jan. 23, 2003

(54) Computer with a modified north bridge, security engine and smart card having a secure boot capability and method for secure booting a computer

(76) Inventor: Jose Tello, Vancouver (CA)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/908,769

(22) Filed: Jul. 19, 2001

(51) Int. Cl. H04L 9/00

(52) U.S. Cl. 713/164

(57) ABSTRACT

A method and system to provide secure boot process for a personal computer. A security kernel forming part of the invention typically resides in the upper area in memory for encrypting/decrypting data from any application that is running under the operating system. The invention allows two operating systems to work separately using the same hardware. The method and system also provides real time encryption for any peripheral that has been selected for which encryption is required during run time operations such as while receiving or sending confidential information over the Internet using a modem or network connection. In place of a standard BIOS, the invention utilizes a security engine including a kernel stored in a flash memory, a modified north bridge and a smart card for auto burning the flash memory portion of the security engine and key generation.

### BACKGROUND OF THE INVENTION

Personal computers are well known devices which as shown in FIG. 1 typically include a main central processing unit (CPU) 11, random access memory (RAM) 13, read only memory (ROM) 15, advanced graphics port 16, typically installed on a motherboard along with a power supply (not shown) and controllers for connecting peripheral devices such as hard disk drive controller 17, floppy disk drive controller 18, CD-ROM controller (not shown), mouse controller (not shown), keyboard controller 19, video controller 21, network card 23, north bridge 25, south bridge 27 and the like. Some controllers are built as logic circuits which plug into the motherboard while others are part of cards which are inserted into slots on the motherboard. Typically included in ROM 15 is code which functions as a Basic Input Output System (BIOS) 29 which allows the loading of an operating system during a boot process, which operating system controls the overall operation of the computer. The BIOS typically tries to load code from a floppy disk as part of the boot process. If the required code cannot be located on a floppy disk, the BIOS then tries to load the necessary code from a hard disk.

In certain environments, where a high level of security is necessary, it is desirable to prevent the computer from booting from a floppy disk or a hard disk since to do so would allow unauthorized access to the computer since code on the floppy disk or hard disk could be modified to bypass password login procedures to allow access by unauthorized persons.

The present invention provides a method and apparatus for ensuring that a computer can be booted only by authorized personnel. Other advantages over prior art systems are provided as set forth below.

### SUMMARY OF THE INVENTION

A method and system are disclosed to provide a safe and “Personalized” boot process for a personal computer having a main memory, a main CPU, PCI bus, keyboard, mouse, hard disk drive, floppy disk drive, possibly other peripheral devices, an operating system such as Windows 2000 and a security kernel forming part of the invention which typically resides in the upper area in memory for encrypting/decrypting data from any application that is running under the operating system. The invention allows two operating systems to work separately using the same hardware. The method and system also provides real time encryption for any peripheral that has been selected for which encryption is required during run time operations such as while receiving or sending confidential information over the Internet using a modem or network connection. A security engine component of the security kernel includes routines that set up TCP/IP connections in order to authenticate a user's computer and encrypt/decrypt the data flow in real time.

A personal computer according to the invention will not have a flash memory or ROM on the motherboard for storing a standard Basic Input Output System (BIOS).

In place of a standard BIOS, the invention has the following components:

Security Engine

The security engine has the following parts:

A processor such as an Intel x86 core processor with an internal flash memory. This processor initializes the hardware, an extended BIOS, host bridges, peripherals (parallel, serial port, keyboard, USB, hard disk drive, floppy disk drive, etc.). By using a flash memory, a digital signature can be addressed safely, and also can be changed at any time. In addition, code for performing encryption/decryption and key management is stored in the flash memory.

A 32 bit kernel stored in the flash memory to provide easy peripheral driver support to initialize add on cards and to enable through the security engine, for example, direct access to the Internet to enable a download of any operating system.

Extended flash memory to cover all possible hardware designs and provide a kernel for the most popular operating systems.

2) Modified HOST/PCI Memory Controller Hub, or North Bridge

Due to different topologies and speed requirements for the host bus, the invention requires a modification of the memory controller hub, also known as the north bridge, in order to provide access by the security engine to the entire hardware after a power-on or reset. Also, these modifications allow access to the main memory for encryption/decryption in real time after the operating system has been loaded.

Smart Card

The smart card is responsible for auto burning the flash memory portion of the security engine. It also is responsible for key generation. The smart card has three areas: key generation, digital signature, and application area (this area allows storage of a third party digital signature for its own application).

### BRIEF DESCRIPTION OF THE DRAWINGS

FIG. 1 is a block overview diagram showing the components of a prior art personal computer.

FIG. 2 is a block overview diagram showing the components of a prior art personal computer incorporating the modifications of the present invention.

FIG. 3 is a block overview diagram showing the elements of a security engine.

FIG. 3a is a block overview diagram showing how the security engine interfaces with the modified north bridge.

FIG. 4 shows a memory of a processor of the type used in a personal computer is divided into two parts: 10 address and memory address.

FIG. 5 is a block overview diagram showing the elements of a security engine.

FIG. 6 is a block overview diagram showing the elements of a security kernel.

FIG. 7 is a memory map showing the location of the security kernel.

FIG. 8 is a flowchart showing the setup device driver layer of the security kernel

FIG. 9 is a flowchart showing how a digital signature is created.

FIG. 10 is a flowchart showing the steps for checking a digital signature during a boot process.

FIG. 11 is a block overview diagram of a modified north bridge.

FIG. 12 is a block overview diagram showing the topology for addressing the security engine.

FIG. 13 is a flowchart showing the power on and reset procedures.

FIG. 14 is a flowchart showing steps for using the digital signature.

FIG. 15 is a block overview diagram showing the elements of a security folder.

FIG. 16 is a flowchart showing how the remote server can request its own data in a secure manner.

FIG. 17 is block overview diagram how the security engine and the smart card are connected together.

### DETAILED DESCRIPTION OF THE INVENTION

The present invention replaces the original basic input output system (BIOS) of a personal computer with the following components: security engine with security kernel, modified north bridge, and smart card.

Security Engine

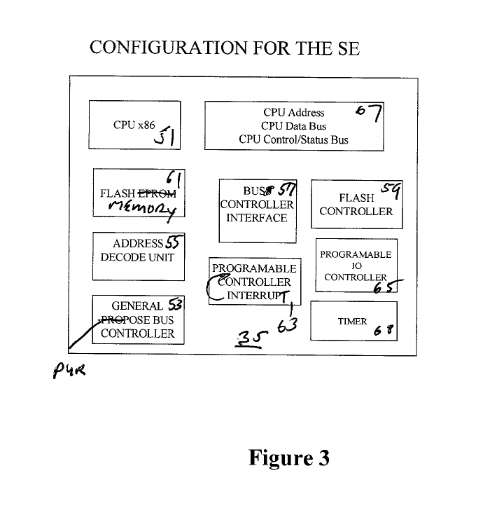

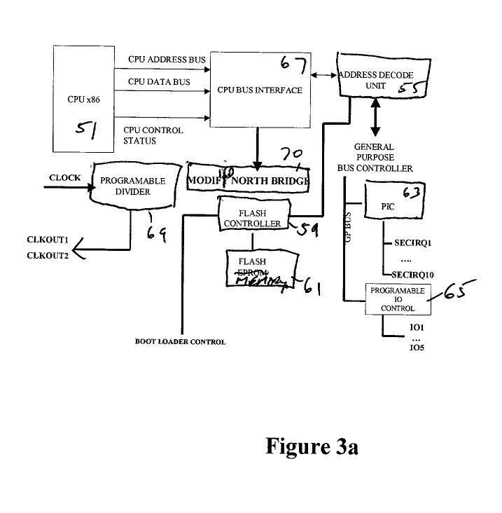

The security engine 35 as shown in FIG. 3 includes the following components:

A processor 51 such as an Intel processor

Bus controller 53

Address decode unit 55

Bus controller interface 57

Flash memory controller 59 and flash memory 61 containing a security kernel.

Programmable interrupt controller 63

Programmable 10 controller 65

CPU Bus interface 67

Timer 68

The flash memory controller 59 includes a state machine and circuit logic for address write and read procedures from the flash memory. Another task for this controller is to allow the burning process for the flash memory 61. The bus controller interface may be implemented as a state machine having the logic to create the necessary timing for connecting the security engine to the modified north bridge.

The programmable 10 controller 65 and general purpose bus controller 53 are implemented using standard logic that allows the flow of the information between digital 10, address and data for the flash memory.

The programmable interrupt controller (PIC) 63 provides the capability to prioritize 22 interrupts levels, up to 15 of these being external sources. The PIC can be programmed to operate in PC/AT-compatible mode, but also contains extended features, including support for more sources and flexible routing that allows any interrupt request to be steered to any PIC input. Interrupt requests can be programmed to generate either non-maskable interrupt (NMI) or maskable interrupt requests.

The security engine uses an Intel or equivalent processor 51 which needs to be initialized by the security kernel as explained below. Logic inside the security engine ensures that instead of allowing reads from external flash memory after a warm or cold restart, reads are performed only via the internal non-volatile memory 61 typically implemented as flash memory.

The invention also enables installation of an operating system over a network. After the computer has been personalized, the security kernel can connect the computer with a remote server and through TCP/IP protocols download the operating system and install the necessary drivers.

The main idea is to change the meaning of the booting process of a computer system such that before the operating system is in place, a user can create a unique digital signature and key for encryption/decryption. Another feature is by using the application area from the smart card, a pre-registration by a third party (e.g., an OEM) can be completed. This means the combined security engine and security kernel can store a digital signature for a credit card. This will allow download of operating system software over the Internet. To provide data security, the invention uses a one time pad system so no pre-storage of a key is required.

In order to load the operating system, the security engine checks the digital signature through the smart card if the hardware has been initialized. If not, the security engine will initialize the hardware needed to allow the user to personalize the computer. After that, the operating system will perform power on self test (POST) procedures, then the security engine will provide all data necessary such as, for example, the interrupt vector, initializing the hardware, plug and play table, legacy I/O address assignment, creating a system resources map for the used and unused resources (DMA channels, IRQ, memory). For the last part of the initialization, the security engine will initialize the main CPU, and bootstrap the operating system from any driver that the user chooses.

The first time a computer is used, the security engine needs to do the following major steps:

Personalization Procedures

Creation of Digital Signature

Key Management

Auto Burning Procedures

Hardware Initialization

Partitioning and formatting of the hard disk for use by any operating system.

Setup networking procedures if software needs to be downloaded.

A standard BIOS can detect the hard disk drive but cannot install the operating system until the partitioning and formatting has been done. The present invention provides this capability for the most popular operating systems. Another feature is that an operating system can be downloaded through the Internet. This can be done because the security engine can establish a one time pad transaction as described below for encryption/decryption over a network.

One Time Pad System Description

The One Time Pad System, OTPS, helps to alleviate the security problems created when parties communicate over unreliable links. OTPS uses a single key to encrypt/decrypt messages. When the communication between the parties is terminated, a code in the security kernel destroys all of the data concerning the key. This system makes it impossible for anyone to reconstruct either the key itself or the plain text that the key represents. It is to be appreciated that OTPS allows parties to transfer information in real time over a network without the need for any key exchange . Moreover, OTPS helps minimize the amount of information exchanged between the parties. Thus, OTPS establishes a system where transactions between parties may be completely quickly, securely, and with minimal overhead.

Generation of the “Seed” for the Random Number Generator (RNG)

In order to create a key for the OTPS, each of the parties involved in the transaction generates a seed for a true RNG (256 or 512 bits length). Then, each seed is used in order to create a random key. Since the seeds are used for the generation of a key for the OTPS, the seeds are hidden while the digital signatures are being checked,

Sending Credentials: Checking Digital Signatures

Sending credentials means checking the digital signature on each computer involved in a transaction. Before each transaction, each computer will check the digital signature of other computers. An arbiter computer will be used to start and finish sending the credentials. For example, three computers named A, B, and C may need to transfer information to each other in a real time transaction. If A is the arbiter computer, then A will send its credentials to B and C, B will send its credentials to A and C, and C will send its credentials to A and B. When A sends its credentials to B and C, code inside the security kernel of B and code inside the security kernel of C will each independently check the digital signature of A. If, for any reason, the digital signature of A fails, the transaction cannot be established and it will be stopped in all security code kernels. Thus, this system protects parties against malicious attacks by adversaries who do not have the proper digital signature.

Generation of the “Seed” for the Random Number Generator (RNG)

Every security kernel will have three sources of creation: (1) a timer (T), (2) the RAM from an AGP compliant video device, and (3) the digital signature (DS) from the computer. The first source is the timer (T). The security engine will read T and will store it into a variable having a length of 32 bits. The second source is the RAM from the AGP compliant video device. The security kernel will create a checksum of 64 bits with overflow. The checksum calculated will be: ChK_S:=ΣA(I), where I=0 to maximum address. Both the address and the length of the interval (amount of bytes from video memory) will be selected randomly. The last source is the digital signature (DS). The DS sums a series of permutations from primitives that are defined by the kernel. The objective is to protect the secrecy of the parameters of the user's DS. The primitives are XOR, AND, NOT and OR. The DS array will be transformed by the primitives function from the timer and from the digital signature array in which the array is divided into 32 bits blocks: DS′=F(DS, T). The seed of the RNG is formed as follows: RNG=ChK_S∪T∪DS′. This number will be created for each party that is involved in a real time transaction over the network. All of these calculations are performed by the security kernel.

Sending the Seed of the Random Number Generator (RNG) to all the Members

After the seed has been created by the security kernel, each party involved in the transaction must send its own seed to the other computers. This invention uses the “random oracles model” in order illustrate two properties: (1) “total secrecy” and (2) “unpredictability.” In “total secrecy,” it is assumed that if H is a cryptographic hash function, then H(t) “gives no information on t.” In “unpredictability,” it is assumed to be impractical to find at such that H(t) would have a desired property.

When the digital signature is checked under the Guillou and Quisquater scheme, the verifier will need to send a number, n=p.q, such that p and q are both secret primes. This invention imposes the condition in order to make “n” a large, safe prime. “n” is safe if q=(n−1)/2 is a prime.

Now given as input the RNG=x calculated before, a random element r in Z needs to be chosen and let H(x)=r**2, r**2(h(x), where the calculations are modulo p, and h is any collision resistant hash function. Verification is straight forward in order to verify whether a pair a,b is a hash of a known message x=RNG, check to see if a**(h(x)≡b (mod p)).

The security of this construction is based on a strong variant of the Diffie-Hellman assumption. This scheme involves a modular exponentiation, in which strong calculations are necessary in order to preserve the security goals and to handle the architecture chosen by the security engine.

The construction of r, and r**(x) proceeds as follows:

Let p be a large safe prime, i.e. p=αq+1 where α is small integer. Let Q be the subgroup of order q in Zp (i.e., Q is the group of squares modulo p). On input m and random input rεQ the oracle hash function H first computes x=h(x) where h is a collision resistant hash function. Next, it outputs h(m,r)=r,r**x. The verification algorithm V is straightforward. Given an input m and a hashed value <a,b>, compute x=h(m) and accept if a**x=b. This is based on the assumption of Diffie-Hellman.

For cryptographic hash functions, the invention in one embodiment uses the MD5 algorithm, due to the “diffusion and confusion” properties it possesses.

The seed of the RNG that each party calculated will be protected by this random oracles algorithm. Each security kernel will use the seeds of the other parties, as well as its own in order to generate the random key for OTPS.

Random Number Generator (RNG) Key for One Time Pad System (OTPS)

After the seeds are received, each security kernel generates a random Key. Combining parallel multiple recursive sequences provides an efficient way of implementing random number generators with long periods and good structural properties. Such generators are statistically more robust than simple linear congruential generators that fit into a computer word. It is now recognized that random number generators (RNGs) should have very large periods, which are several orders of magnitude larger than what is practically useful. For example, all full-period linear congruential generators (LGGs), or multiple recursive generators (MRGs), have period lengths that exceed 2**100.

In light of to the explanation above regarding the role of each party in the generation of a seed, this invention demonstrates that the seed is a pure random number, and that this seed covers the expectations of a random interval much more than 2**150, in which the interval proposed for the key random number generator provides an excellent and strong encryption key.

In 1996, L'Ecuyer proposed a Combined Multiple Recursive Generator (CMRG), where the components are carefully selected so that the generator has good structural properties, while each component remains easy to implement in an efficient manner. The recurrence of the CMRG can have large coefficients, even if the components have only two small nonzero coefficients.

A multiple recursive generator of order k is defined by the linear recurrence:

X(n)=(a1X(n−1)+ . . . +akX(n−k) mod m;

U(n)=Xn/m;

where m and k are positive integers, and each ai, belong to Zn={0, 1, . . . , m−}

The equation used to implement the random key , according to L'Ecuyer, combines J copies of the equation generated above, such that:

x(j,n)=[a(j,1)x(j,n−1)+ . . . +a(j,k)x(j,n−k)] mod m(j)

for j=1, . . . J, where mj are distinct primes (mj is taken from the seed that was sent by every member involved in the real time transmission) and the Jth recurrence has order k and the period length m**k(j)−1.

The algorithm used for this invention is the best mode, but of course another algorithm can be implemented for the generation of the OTP Key.

In order to create the table for the coefficients a(j,i), it is mandatory to consider the following conditions according to L'Ecuyer:

The product a(j,i)(m(j)−1) is less than 2**53.

The coefficient a(j,I), satisfies a(j,I)[m(j) mod (a(I,j)]<m(j).

The coefficient a(I,j) needs to have a good figure of merit.

With these conditions, the security kernel will have a code for creating the table of combined MRGs. Due to the speed of the CPUs currently available, this invention uses 64-bit integers, of a CMRG to generate and add 10**8 random numbers.

One Time Pad System (OTPS)Cryptographv over the Network

The term “one time pad system” refers to any method of encryption where each byte of plain text is encrypted using one byte of a key stream. Each key byte is used one time, but then is never used again. The key stream for a one time pad must be a true-random stream. This means that every key byte can take any value from 0 to 255 with equal likelihood, and that it is independent of the values of all other key bytes. By contrast, in a pseudo-random stream, the value of each byte after the first several ones is mathematically derived from the values of the preceding bytes.

A one-time pad encryption scheme can be denoted as:

C(i)=E(P(i), K(i)) where E is the encryption operation (i.e. XOR, AND, NOT, OR), P(i) is the i-th character or array of characters of plain text, and K(i) is the i-th byte or array of the RNG. The key for each individual message is the starting location in the entire random key stream used for this encryption scheme. For efficiency, it is good practice to start each message near the position following the key byte (or array) used for the last character (or array of characters) of the previous message. This eliminates the need to keep track of the portions that have been used, and removes the danger that a message will be longer than any of the remaining segments. Using this scheme will not cause a problem for encrypting/decrypting datagrams under TCP/IP or other protocols that any software application can use.

Memory Map

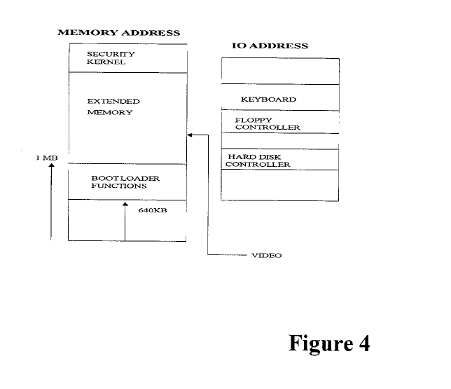

An Intel or equivalent processor of the type used in personal computers utilizes a memory which is divided into two parts: IO address and memory address as shown in FIG. 4. The keyboard, parallel/serial port, hard disk drive controller, floppy disk drive controller are found in the IO address space. The memory address space contains control, status registers, for enumerating the PCI buses. All buses below #0 are assigned a single range of pre-fetchable memory, a single range for the peripherals. The video card can be setup in this area if an AGP card is found, an aperture size register will be set by the kernel during the POST process. In the IO address space, the keyboard controller, the floppy disk drive controller and hard disk drive controller are initialized.

Boot Loader Functions

x86 architecture utilizes memory between 640K and 1 MB to decode the BIOS.

In the address range FFFF0000-FFFFFF, the main CPU starts the code initialization after power-on or reset. In the present invention, the modified north bridge disables/enables the main CPU and the security engine initializes the entire system and provides the interrupts for legacy-operations in order to load operating systems like Windows, Linux, etc.

This area will have the following parts:

Code for enabling and initializing the main CPU is executed by the security engine after the initialization procedures has been in place and the security functions have been completed. At this time the main CPU is initialized.

Code for the interrupt handler is also executed to load any operating system so the main CPU will have all the necessary functions to bootstrap the operating system.

The interrupt services are:

INT8 System timer

INT9 Keyboard is invoked only by software and does not use IRQ1 signaling, however, for proper system operation this handler must perform the same operations as on legacy systems:

The interrupt handler needs to be in the IVT chain for INT9

b IRQ1 is unmasked at the PIC

INT10 Set Video Mode

INT11 Equipment determination (if there are devices that appear as floppy drives and CD-ROM drives

INT12 Memory size 0

INT13 High-capacity drive support

INT14 Serial Communications

INT15 System Services

INT16 Keyboard and the following sub-functions: Get Keystroke, Check for Keystroke, Get Control keys, Get enhanced keystroke, Check for enhanced keystroke, Get control keys for enhanced keyboard

INT19 Bootstrap loader

INT1A get-set real time clock functions.

INT1BCTRL+Break Handler

INT1C Timer Tick, 5650h Get address of PXENV Entry Point

INT23 CNTRL+C, CTRL+Break Handler

Another difference between the invention and prior art systems is the handling of warm and cold resets.

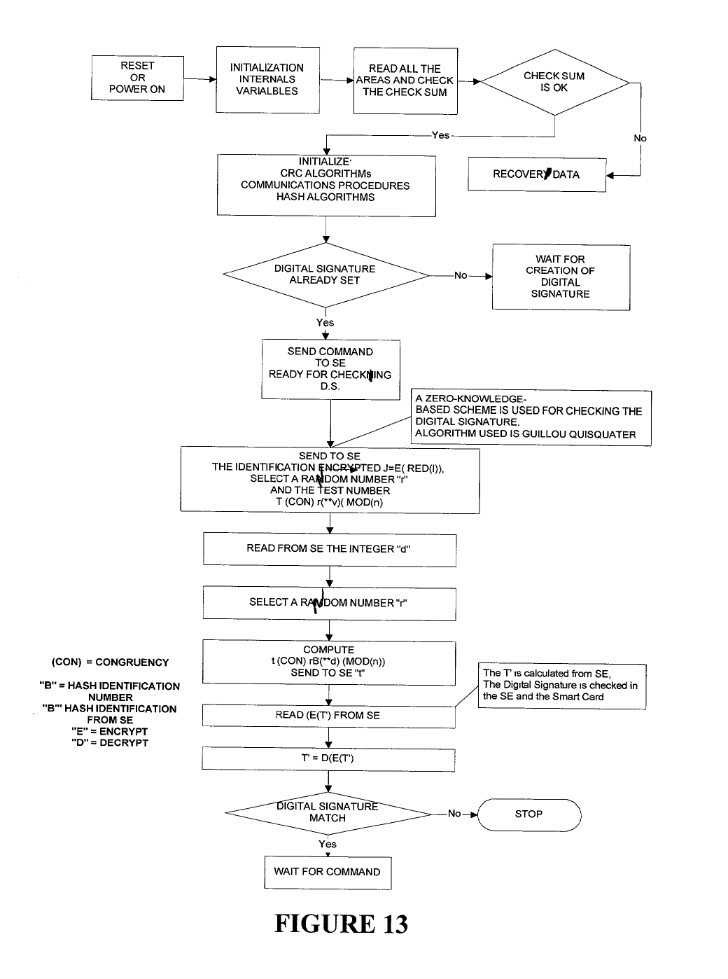

When a “warm reset” is asserted, the security engine will intercept this signal and start with all the procedures for initialization of the main CPU, setup the interrupt vector. The security engine will not be initialized, and the security kernel will not need to re-load and the security procedures will not be checked. More details can be found in the flowchart shown in FIG. 13 illustrating cold-warm reset.

Security Engine Block Diagram

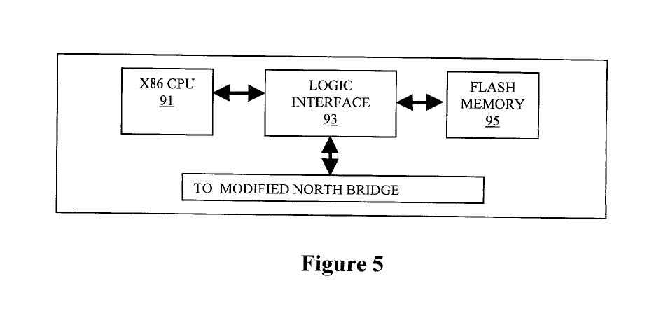

The security engine has three major components as shown in FIG. 5: CPU 91, logic interface 93, and flash memory 95.

The CPU 91 is an x86 Intel or compatible processor because the security engine needs to run software which has been written for Intel or compatible processors. Another reason is that the extended ROM BIOS for add on cards runs x86 code for IBM compatible personal computers.

Also needed is a logic interface 93 in order to provide:

A bus interface needed for signals like CPU address, CPU data, CPU control status, I/O as well as the signals for access to the main memory through the modified north bridge.

An address decoder having an interface for creating digital I/O to control external peripherals (like smart card and fingerprint sensor).

A bus needed for control of the flash memory (address, data, and the functions read, write, and memory selection); after a power-on or reset, the kernel needs to be loaded into “shadow memory” (described in the memory map). Such logic needs to be implemented to detect this event and to provide the possibility of reading the code inside and executing the same from the shadow memory.

Logic circuit to implement acknowledgement of events that have been enabled in the setup procedures during the auto burning process.

A boot loader circuit to initialize the flash memory to reset the x86 CPU

As an example of the major components described above, FIGS. 3 and 3a explain how the security engine works.

The invention provides a security engine that is capable of running in stand alone mode, and includes code capable of initializing the computer (react to power-on or reset) and provide functions for encryption/decryption in real time and networking access (TPC/IP protocols).

The security engine also has the capability to create a unique digital signature and key management to control the entry of a user's personal data. Since no pre-stored key is required, this transaction will be made between the smart card and the security engine.

This process is controlled by hardware and software which provides for auto burning of the flash memory. Another feature of this security engine is to handle interrupts for peripherals from the computer which need to be controlled by the security engine.

The invention provides two major security features:

When a key management and digital signature are created, the components involved are the security kernel and the smart card. This ensures that no intrusion is possible by any debugging tools under any operating system.

In normal operation, the security kernel is stored in a security kernel area. This portion of memory is not accessible to any operating system. Thus under no circumstance can a memory debug be achieved.

These two security features are enabled by the modified north bridge through the secure memory controller of the modified north bridge.

CPU Bus Interface:

This CPU bus interface 67 has the responsibility of interfacing the CPU address bus, CPU data bus, and CPU control status signals bus to the modified north bridge 70, and the address decode unit.

Also this block handles the flow of address/data/control between the modified north bridge and address decode unit, i.e., when data needs to be sent to the smart card. The general purpose bus controller 53 provides logic circuits (state machine, latches, etc.) for interfacing the peripheral devices with the security kernel.

Address Decode Unit

The address decode unit 55 decodes the address from the flash memory after reset or power on. The control signals RD and CS are also controlled.

During the auto burning process, the WR control signal (that is part of the boot load control) signal is controlled by the smart card.

This block includes a hardware protection to burn the flash memory. If the security condition is established, it will be impossible write any code into the memory.

Thus, the invention provides boot loader control signals to bum the flash memory for the first time. An external software is needed to burn the code without decreasing the security features provided by the invention.

Programmable Clock Divider

Programmable clock divider 69 uses clock pins designed to either source or sink 24 mA. The maximum amount of capacitive load that can be placed on a clock pin is determined by the required rise/fall times. The two CLK OUT signals can be used for the smart card and a fingerprint sensor. As an example, suppose that the system requires a rise/fall time of 1 ns, with a voltage swing of 2.5 V. Then, the maximum capacitive load is Cₘₐₓ=24 mA/(2.5 V/1 ns)=9.6 pF.

The accuracy of the real-time clock (RTC) depends on several factors relating to crystal selection and board design. A clock timing budget determines the clock accuracy. The designer should determine the timing budget before selecting a crystal. There are four major contributors to a clock timing budget.

Frequency Tolerance—This is the crystal calibration frequency. It states how far off the actual crystal frequency is from a nominal frequency. For a typical 32.768-kHz crystal (watch crystal), the frequency tolerance is ±20 parts per million (ppm). Frequency tolerance is specified at room temperature.

Frequency Stability-This parameter is a measure of how much the crystal resonant frequency is influenced by operating temperature. For watch crystals, typical numbers are around −30 ppm over the temperature range.

Aging—This parameter is how much the crystal resonant frequency changes with time. Typical aging numbers are ±3 ppm per year.

Load Capacitance—The crystal is calibrated with a specific load capacitance. If the system load capacitance does not equal the crystal load capacitance, a timing error is introduced.

General Purpose Bus Controller and Bus Controller Interface

The general purpose bus provides a simple interface to the integrated on-chip peripherals, as well as external peripherals. The general purpose bus operates at 33 MHz.

The general purpose bus controller 53 provides one fixed timing set for the internal peripherals and one programmable timing set for the external peripherals. The general purpose bus is used to provide a full complement of integrated peripherals such as a programmable interrupt controller (PIC) and IO controller. The internal peripherals are designed to operate at the full clock rate of the general purpose bus.

The general purpose bus interface 57 can be programmed by software to control the interface timing between the general purpose bus and the external devices. The general purpose bus interface supports programmable timing, dynamic data width sizing, and cycle stretching to accommodate a wide variety of standard peripherals.

General purpose bus accesses can be initiated only by the security engine CPU. The devices on the general purpose bus are not cacheable from the security engine CPU's viewpoint.

External devices that assert interrupts use the SECIRQ1-SECIRQ10 signals for this purpose. The SECIRQx interrupt signals bypass the general purpose bus controller and are routed to the programmable interrupt controller (PIC) 63. The security engine microcontroller's programmable interrupt controller (PIC) includes two industry-standard controllers, integrated with a highly programmable interrupt router.

The programmable interrupt controller 63 is configured so that two controllers are cascaded as slaves to a master controller that arbitrates interrupt requests from various sources to the security engine CPU. Interrupt channel 2 (IR2) and channel 5 (IR5) of the master controller are hard-wired to the outputs of the Slave 1 and Slave 2 controller respectively. In this configuration, up to 15 maskable interrupt channels of different priorities are available to the programmer.

The programmable interrupt controller 63 handles routing of the various external and internal interrupt sources to the 16 interrupt channels of the three controllers. The interrupt controller can also be programmed to handle routing of various NMI sources to generate a non-maskable interrupt to the CPU. The security engine microcontroller's programmable interrupt controller is designed to support PC/AT-compatible features. Startup software can configure the programmable interrupt controller to route the sources to be used as ISA interrupts to the appropriate interrupt channels of the Slave 1 and Master controllers.

PCI interrupts are level-sensitive, shareable, and typically implemented as open-drain inputs. To support this, the programmable interrupt controller optionally allows the selection of edge-triggered or level-sensitive interrupt detection on a per-channel basis, as an alternative to the standard global selection of edge-triggered or level-sensitive detection on all channels. This enhancement provides maximum flexibility in configuring a system environment where mixed interrupt types are used.

Features of the security engine microcontroller's programmable interrupt controller include:

14 interrupt priority levels plus NMI

Programmable interrupt router capable of mapping interrupt sources (internal and external) to different priorities or NMI

Ability to assert any of the interrupt priority levels, including NMI, via software

Configurable to provide software compatibility with PC/AT interrupt controller

Block Address Circuit

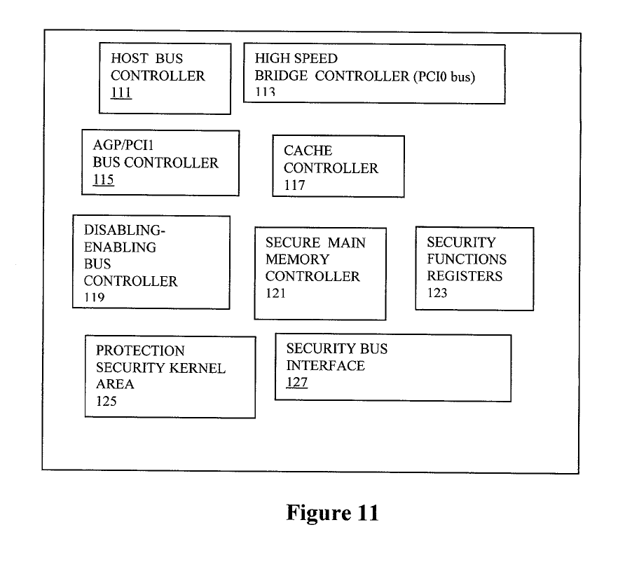

A logic circuit which is part secure main memory controller 121 shown in FIG. 11 is needed to monitor the security kernel area. The main CPU will not have any access to this area except for the Security Address Register which is the only way to communicate, transfer information between the operating system (handled by the main CPU), and the security kernel (handled by the security engine).

Security Bus Interface

The security bus interface 127 shown in FIG. 11 includes logic circuits to decode system memory transactions generated by the security engine processor, such as address, data, control signals, and status.

From this block, the security engine is able to handle any security function that the kernel provides, without conflicting with the geographical hierarchy between the individual peer host/PCI bridges.

Security Kernel

The security kernel includes the following components:

Main memory partitioning code

Creating/checking digital signature

Smart card code

Security engine interrupt table

Auto burning process

File system code

Handler for driver allocation code

Digital signature /encryption algorithms

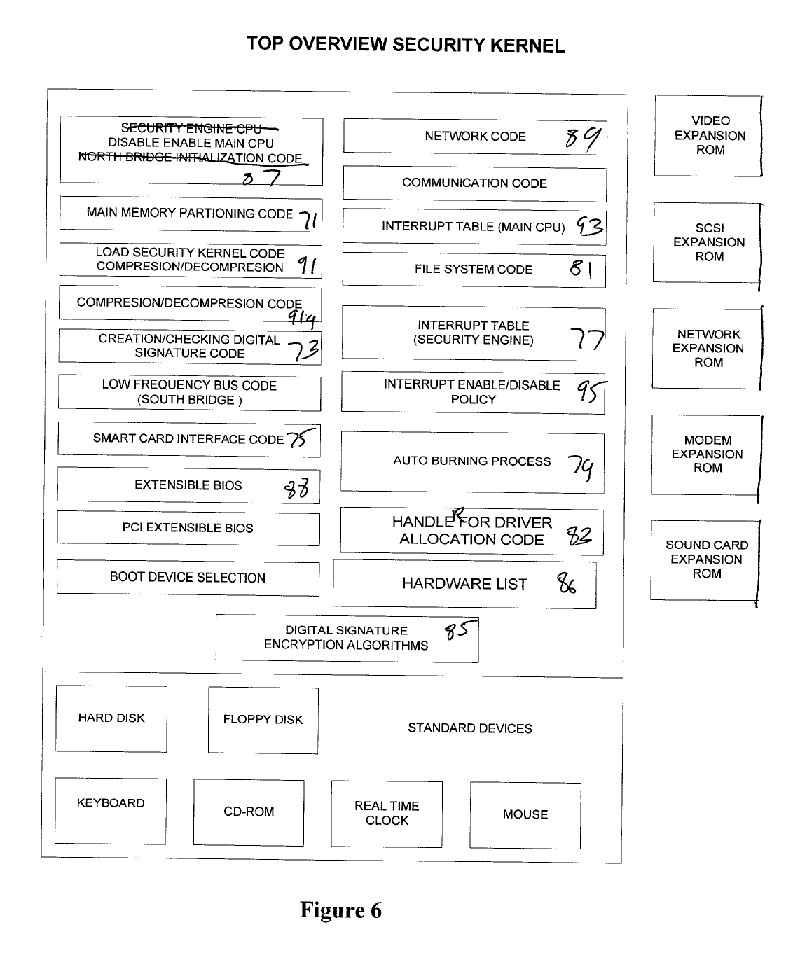

With reference to FIG. 6, the invented security kernel has the following functions:

React to Power On or Hard Reset is the code referred to as Security Engine CPU, DISABLE/ENABLE Main CPU North Bridge Initialization Code. This code is the first the security engine code that will execute after a power On or Reset.

Provide an interrupt table 93 mapped into the main memory for the main CPU, in order to load any operating system, as well as an interrupt table 77 for the security engine to provide access to any peripheral that has been selected.

Recognize and initialize boot devices and hierarchical buses using Extensible BIOS, PCI Extensible BIOS, Boot Device Selection

Creation and checking of a user's digital signature using creating/checking digital signature code 73.

Create a hardware list 86 in order to allow the user to install any operating system over a network.

Capability to boot from any device or bus added to the personal computer by allowing storage into the flash memory boot code for new devices using the Handler for Driver Allocation Code.

The kernel also provides the capability to load any device driver for any device. This provides an advantage in the initialization process. For example, any USB device can be initialized as part of the boot process and can be used if it is necessary in the boot process.

The idea is to have two kernels working in parallel so that the security kernel will be stored in the same shadow memory as the kernel for the regular operating system. It needs to be transparent to any operating system access to the main memory. BIOS functions will be replaced security kernel functions. With this assumption an email check in real time can be provided.

With the introduction of a replacement of the standard BIOS by the security kernel and security engine, the invention also enables the creation of a wireless computer concept.

Due to the large increase of the bandwidth in digital wireless communications, the idea is to send a hardware list (for the “Hardware Abstraction Layer”) to a server and download any operating system for this particular hardware and install it into the main memory or a flash memory backup. This creates a new environment for installing a wireless operating system scheme in an online environment. Most operating systems have been created to handle many IO operations for ISA, PCI, USB, Serial/Parallel Port, etc. According to the present invention, it is only necessary to download from a server the I/O manager required for the target hardware.

For example, if the hardware is a cellular phone, the hardware list that the security engine will send to the server to download the operating system will be: keypad, mouse, embedded memory capacity, modified north bridge, LCD display (Resolution=256 Colors), ISA Bus (if the radio frequency hardware is in an ISA bus). In order to communicate under the hardware setup procedures, the system will install the communication driver for the cellular phone in question.

Most major operating systems have an encryption system embedded in order to provide security for the mass storage devices. The present invention provides a mechanism to speed this process and in more secure way through the security engine. The security kernel provides encryption/decryption in real time for mass storage devices, without requiring an extended resource from the main CPU as is typically the case with the prior art.

The security kernel includes code 87 for enabling/disabling the main CPU. This is implemented in conjunction with the modified north bridge as explained below.

The north bridge initialization and the rest the of hardware are not modified.

Indeed all the hardware initialization code will follow the standard posting procedures from the standard BIOS, for example hard disk controller, floppy disk controller, keyboard, CD-ROM controller (through IDE bus), real time clock, mouse controller, and standard devices such as those connected to the serial/parallel port.

Load Security Kernel Code—Compression/Decompression 91: most operating systems include code that is stored in the hard disk in the bootstrap sector, from which it starts loading the kernel. In the invention, the kernel is stored in flash memory and is not obtained from a hard disk or a floppy disk. Software modifications to the operating system are needed to allow the security kernel to be installed into the secure DRAM area. These modifications are designed for loading mass storage devices (e.g., HDD) every time the computer is turned on. The modifications also include a file system table allocation built into the HDD. In this case, the kernel is modified so it can be loaded from the flash memory, so it does not need to load any file allocation table. The security kernel includes code that will partition and format the hard disk in order to install any operating system.

Interrupt table (main CPU) 93—In this part, the process flow has been changed from the standard POST procedures. The intention is to provide to the main CPU, the ability to have an interrupt vector table, system BIOS stack and system BIOS segment, set up in the lower area of DRAM memory and also to be compatible with the standard POST procedures in order (after the security procedures have been completed) to boot any operating system that has been stored on the hard disk.

Interrupt enable/disable policy 95: This part allows the security kernel to handle or not handle any device from the PCI bus (high frequency bus) or ISA (low frequency bus). The enabling or disabling is selected by the user. A menu is provided in the security kernel from which the user selects which peripheral will be handled entirely by the security kernel and not from the operating system. For example, if a network card has been selected, the security kernel will identify the resources for the network card, and code within the kernel will enable the driver for the network card that is inside the kernel (communication code, networking code) which will handle all transactions between the computer and the server. An encrypt/decrypt function can be achieved in real time and flow of data between the security kernel and operating system will be handle by the PCI bridge.

Concurrent operation of main CPU, PCI 0, PCI 1/AGP, and PCI 2/security engine buses is supported via dedicated arbitration and data buffering logic, for example, PCI 0 arbiter, PCI 1/AGP arbiter, CPU bus arbiter (for PCI 0, PCI 1, and PCI 2 traffic).

In the initialization code, due to the hardware capabilities of PCI devices, a new software methodology that coordinates the hardware configuration process at the system POST (or standard BIOS), can be easily identified, along with the functions they provide. In addition, PCI compliant devices identify their individual system resources requirements. These system resources can be dynamically assigned with no user intervention.

A major function of plug-and-play device services is to provide a hardware independent programming interface that allows software to manipulate the computer's hardware. In order to do this, the initialization code reads the configuration space header. This predefined header region contains fields that uniquely identify the device and allow the device to be generically controlled.

Since all PCI compliant devices must support Vendor ID, Device ID, Command, Status, Revision ID, Class Code, and Header Type, the initialization code will create a list of all the hardware in order to share this information with the operating system so that the proper driver is installed.

This technology will allow the use of peripherals that can be personalized and during the boot process can check a user's digital signature. In this manner, a manufacturer of hard disk drives can upgrade to include a strong security feature without having a substantial increase in cost or development time. This will prevent theft from access or use of not only the computer system, but also re-use of any peripheral slot connected to the PCI bus. The security kernel includes code, namely the Digital Signature Encryption Algorithms and Standard Devices which enables this functionality.

The security kernel has a set of routines that handle events after power on or hard reset. One of these routines has the responsibility of initializing the hardware using a “power on self test” (POST), This POST scheme is responsible for checking for the presence or absence of devices within the system, initializing those devices that require software initialization, testing the system hardware, reporting the system configuration and diagnostic status, checking and creating of a digital signature 73, checking the status of a smart card using smart card interface code 75.

The security kernel handles all the bootstrap procedures, extended BIOS procedures 88, encryption/decryption algorithms, one time pad system, networking protocols using network code 89, compression/decompression algorithms 91a, digital signature algorithms 85, interrupt tables 77 and 93, smart card interface 75, file system code 81, checking/creating digital signature 73, handlers 83 for drivers for new devices and buses.

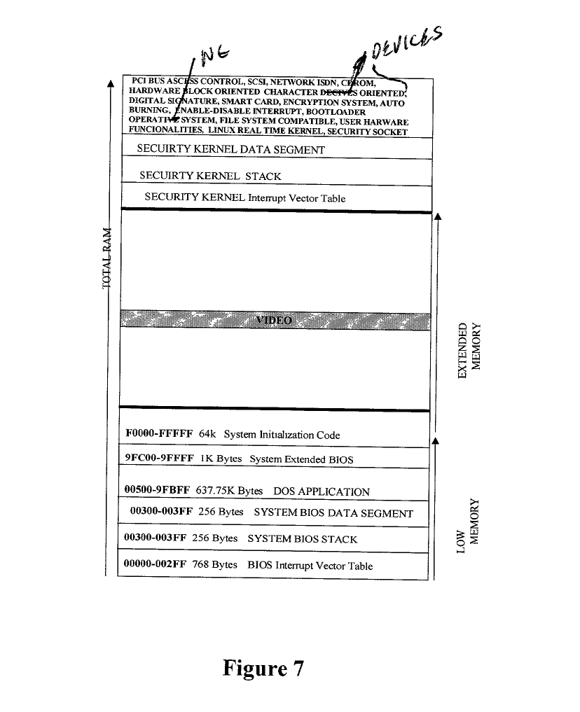

The security kernel is stored in the upper level of the memory as shown in FIG. 7. The size of this portion of memory will depend upon the size of the entire memory. The kernel calculates the minimum memory required in order to install the basic functions for providing a real time encryption system. As an example, if the entire memory is 128 MB the security kernel will use about 13 MB.

The code stored in this area is for the following procedures:

Posting procedures,

Reassigning Bus Number and PCI busses

Bootstrap Procedures

Digital Signature Functions,

Encrypt/Decrypt Functions

Kernel Procedures

Interrupt Table

Communications Functions

Compression/Decompression Procedures

Smart Card Procedures

Networking Functions

File System Functions

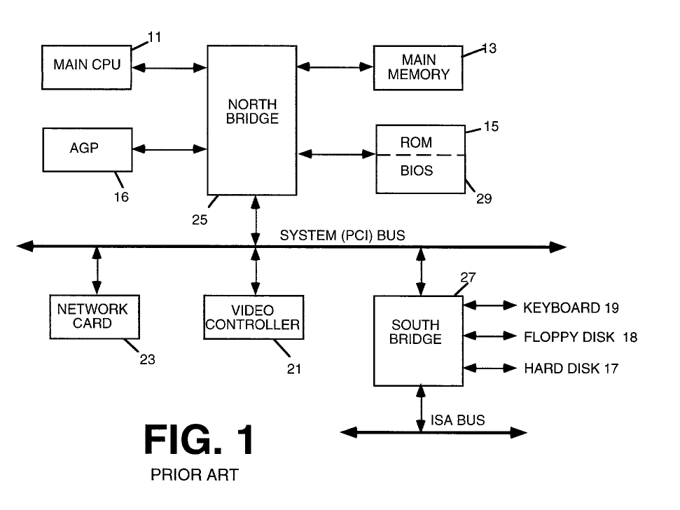

After the memory initialization takes place using a secure main memory controller 121 shown in FIG. 1, the security kernel needs to be loaded into DRAM. The security kernel loops through rows of memory, reading Serial Presence Detect data in order to determine the slowest column address strobe (CAS) latency for all available SDRAM DIMMs. Also the memory size is calculated. The invention based on the maximum memory size takes a percentage for the security kernel. A logic circuit is used to do the following:

Store the Maximum Memory assigned to the Extended Memory. This portion is transparent to the main CPU.

Address Transform for the Security Kernel:

Address “0” means (Beginning of Security Kernel Memory) 1 Mbyte+Extended Memory+1. Address “Maximum Size DRAM” (End of Security Kernel Memory).

Hardware Initialization

After a power-on or a cold reset, a north bridge modified in accordance with the invention, includes logic which automatically enables the bus to which the security engine is connected in order to start the initialization of the hardware. The security engine includes a CPU which is initialized in the same manner as any x86 Intel processor.

As the modified north bridge initialization takes place, the code may initialize all (or some) of the PCIset registers to known values very early during the POST. The code may initialize the entire PCIset registers to a known default state (such as the power-on default state) to perform all dynamic testing. This initialization code will, whenever the system is powered on or the reset button is pressed, cause the PCIset registers to default to known values. However, if the system is reset through software, the initialization code must ensure proper register values.

When the initialization of the RAM 13 takes place, the code reads a ROM (not shown) that has all the relevant information like: timing parameters, RAM size and configuration. This ROM which is an EEPROM within single inline memory modules (SIMM) typically used as RAM 13. This ROM is not referred to in any figures because the SIMMs are simply a particular and well know implementation of RAM 13. Discussion about the ROM is included to explain how the RAM or main memory is initialized according to the invention. This initialization performs the following steps:

The initialization code must loop through each row (typically 8) of memory, reading Serial Presence Detect (SPD) data to determine whether each DIMM forming the memory is single or double sided. Also the software must determine the type of memory contained in each row of memory, and set a DRAM Control Register from the north bridge. Also the code should, at this time, determine the slowest CAS) latency.

The code must next loop through each row of memory and initialize and configure each row of SDRAM.

The code must next loop through each row of memory, reading SPD data to determine the DRAM size.

The code must next program the memory buffer strength control register. This register programs the various DRAM interface signal buffer strengths, based on non-mixed memory configurations of DRAM type (EDO, SDRAM), DRAM density (x8,x16,x32), DRAM size (16 Mb, or 64 Mb), and rows populated.

The code determines the appropriate SPD fields in all of the SDRAM DIMMs and programs the slowest value found in all of the DIMMs searched.

The code calculates the maximum size of the RAM, creates the memory partition and sets the translation registers in the secure main memory controller logic circuits from the modified north bridge. The idea is to have two independent memory areas so that two processors can access their own memory areas. The security kernel is allowed access to the operating system area, but the inverse case is not allowed. Through pre-established addresses, the two processors can share information.

The modified north bridge includes state machine logic, pull up resistors, and pull down resistors inside of its programmable logic device. The registers will recognize a reset or power-on event, and the logic circuits inside will be set to the default condition to disable the main CPU., For the host bus, all the addresses and data lines will be set to high impedance in a way that prevents any signal conflict from occurring.

After the initialization of the CPU in the security engine, the modified north bridge and the security kernel need to set up an aperture size that is within an address range that the advanced graphics port (AGP) video, the main CPU or the security engine CPU use to manipulate graphic objects. This value will be set in the APSIZE register, and also needs to be set up in the AGP Windows for each type of memory, non-prefetchable and prefetchable. This region is defined by the MBASE and MLIMIT registers for non-prefetchable memory, and PMBASE and PMLIMIT registers for prefetchable memory. Note that these registers are PCI defined registers and are located in the PCI-to-PCI bridge (device 1) in the modified north bridge. These registers are set by the initialization code during PCI configuration.

Also during PCI configuration, initialization of the south bridge (or low frequency bus) and the USB bus attached to the south bridge on the PCI bus takes place. The keyboard is detected and its BIOS driver, the keyboard driver code is initialized before another expansion BIOS is detected.

The initialization code includes embedded subroutines for initializing standard devices like hard disk drives, floppy disk drives, mouse, and setup of the real-time clock. The code also has the ability to boot from an ATAPI “bootable” CD-ROM through an IDE bus. The security kernel needs to support the following standards:

IBM/Microsoft extensions to INT13h

ATA task File and ATAPI Packet Interface specifications

ISO-9660 and the IBM/Phoenix Bootable Specification

The code then searches for an MDA device (Monochrome Display Adapter). This is because current PC platforms allow for both an MDA and VGA (Video Graphics Adapter) to be populated in the same system. This capability is exploited by various debuggers. When an MDA is detected, references to MDA resources will be routed to the primary PCI bus regardless of the setting of the VGA Enable bit. If it is not present, references will be routed based on the VGA Enable bit of the BCTRL register of device #1.

The enumeration of the PCI buses take place. A system with an AGP port will require at least three PCI buses. All buses below #0 will be assigned a single range of prefetchable memory, a single range of non-prefetchable memory, and a single range of I/O address.

The initialization code will set the PCI-to PCI bridge registers (Device 1 and 2) MBASE, MLIMIT, PMBASE, IOBASE, and IOLIMIT registers accordingly. This is already part of the standard PCI configuration routines for PCI-to-PCI bridge devices.

During the PCI enumeration, the initialization code will determine the video boot device for the system. All PCI video boot devices (including AGP boot video devices), must contain a 0300h, 0301h in the Class Code register in the PCI (register 0Bh). For PCI video devices, the first one found during the bus enumeration is enabled. The code will search the buses in the order from low to high (bus #0 is searched before bus #1).

If the AGP video device is the boot device, the VGA Enable bit will be set in Device 1's Bridge Control Register. This will ensure that all VGA cycles (memory and I/O) get forwarded to the AGP/PCI #1 Bus. This is already part of the standard PCI configuration routines for PCI-to-PCI bridge devices.

On PCI bus 0, the modified north bridge requests and is assigned a block of address via the Aperture Base Register. Note that the PCIset will have the Aperture Base Register respond via the setting in the Aperture Size Register that was mentioned above. The aperture graphic is now defined.

On PCI bus 1, the AGP card, via its Base Address Register, will request various ranges of prefetchable memory, non-prefetchable memory, and the possible I/O registers.

The security engine is allocated an IO space in the PCI 2 bus, and prefetchable memory is reserved. This will allow the operating system, through any application, to send data to be encrypted or decrypted.

Each type of bus defines its own specific way of carrying expansion BIOS code. For example, refer to, “PCI Hardware and Software Architecture & Design” by Edward Solari and George Willse, Annabooks ISBN 0-929392-59-0. In chapter 17, the “Solari” reference illustrates how the PCI configuration address space enhances every PCI device's Plug and Play capabilities, and how the PCI Expansion ROM provides a mechanism where devices can provide expansion ROM code that can be executed for device-specific initialization. Also “Solari” shows how a PCI device can be detected on the PCI bus doing the following steps:

Read the Vendor ID register of Function 0.

Read the Header Type register

Determine whether the device is multi-function or not.

In chapter 17, “Solari” shows that PCI devices indicate they carry expansion ROM code by reading back ROM-encoded size information at a memory and I/O address range offset of 30h in the PCI Device Header type Region of the PCI Configuration space Header for the PCI device.

Another reference is U.S. patent: U.S. Pat. No. 5,854,905 entitled “Extensible BIOS for boot support of devices on Multiple Hierarchical Buses”. This patent shows the initialization of PCI bridges and sub-buses, and extended ROM BIOS. The security kernel uses techniques disclosed in this patent to initialize different bus topology and expansion ROM from the PCI devices.

The initialization code will initialize the programmable IO Controller from the security engine to match the requirement of the interface for the smart card. In one embodiment, the invention uses a smart card with more than three digital IO buses in order to speed up the data transfer between the security engine and a token card, and for controlling the auto burning process (write to flash memory) inside the security engine.

Up to this point, the initialization code from the security kernel has performed the following tasks:

Initialize the Security Kernel

Disable the Host Bus and Main CPU

Initialize and partition the RAM

Enumeration and set up of PCI buses

Initialization of the south bridge

Initialization (Keyboard, Mouse, Serial/Parallel Port, timer, IDE bus)

Initialization of add on PCI cards.

Detection and initialization of the Video Card.

Interrupt Vector Table (traditional area )

At this point, the initialization code from the security kernel has initialized the entire hardware. It should be noted that the computer has been initialized and controlled by the security engine, not standard software or ROM boot code which can obtain control of the hardware.

Loading Kernel Compression/Decompression

After the initialization has taken place, code 91 a will decompress the kernel and expand into the security kernel memory area. After the initialization of the main memory 13, the flash memory from the security engine will be copied and compressed to the main memory in the area mentioned, and the process of decompression will take place. The algorithm for compression and decompression will be available to the kernel.

The standard BIOS at this point will boot the operating system looking for “Master Boot Sector MBS” in which the code starts at offset 0, and the boot sector is terminated by the magic number AA55h which is found at offset 1FEh. The MBS loads the boot sector of the active partition. If the process mentioned above has an error or has been damaged, the computer will not be able to boot from a diskette in order to try to recover the data on the hard disk drive and boot the computer. This invention through a 32 bit kernel (e.g., Linux), will have the code to boot the computer, install/reinstall any operating system over the network, partition any hard disk drive, without needing the operating system to have been previously installed in any partition of the hard disk drive.

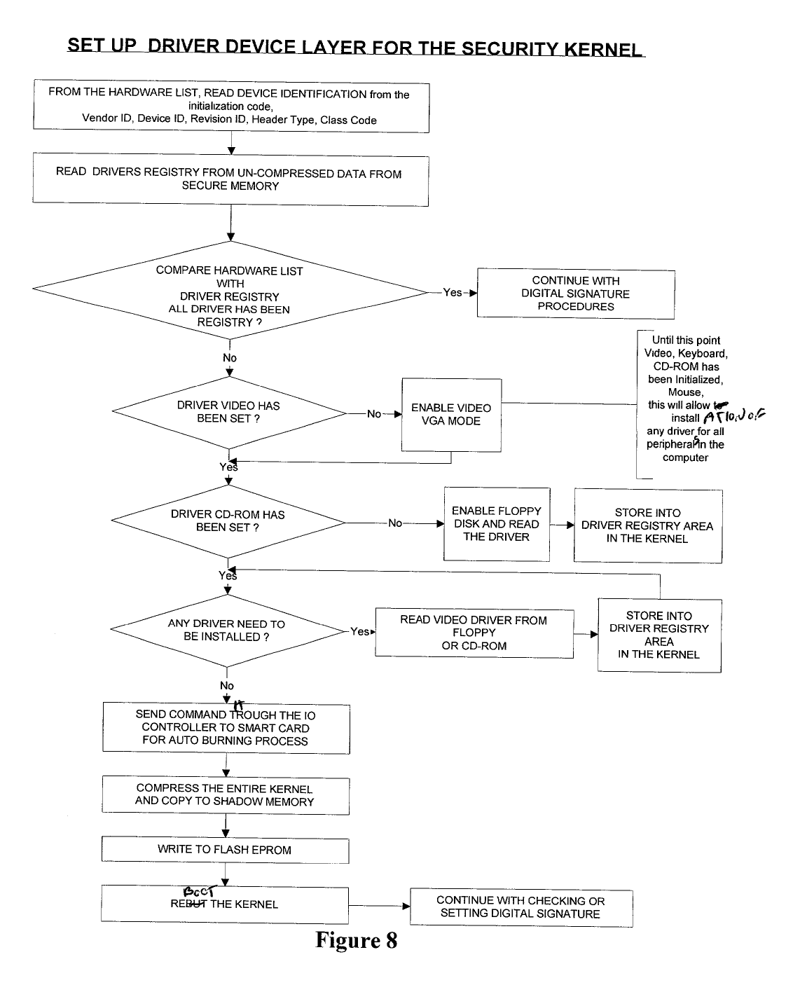

Referring now to the flowchart of FIG. 8, when the kernel is loading, it will need data and the interrupt table 13 from the initialization part is provided. However, to load the kernel into the security area, an interrupt handler needs to be in place in this area. Each interrupt type may have an associated software program that is executed each time the interrupt is invoked. The starting address, or vector, of each of the interrupt routines is stored in a table in RAM. In the prior art, every bootstrap loader for the operating system is performed in Real Mode, before the kernel from Linux (in this case, although another kind of kernel can be used, e.g.,. Windows CE) can be implemented using the following steps:

Read from initialization data Memory Size, PCI Bridge.

Create Stack, Interrupt Handler, Data Segment

Reprogram the interrupt Controller from The Security Engine.

Setup the IO Map Area in order to access any peripheral (parallel/serial port)

Read the PCI Configuration Space Header, for different PCI bus topology

Using a memory translation table, the standard Linux kernel will see the memory area which has been assigned for the initialization code. The aperture video memory will be shared with the operating system. The communication between the operating system and the security kernel is performed using PCI Bridge peer-to-peer. The memory space will be reserved for buffering of data for decryption or encryption.

The loader has been modified for all the procedures respecting the Master Boot Sector in order to load the operating system from the hard disk drive sector “0”. From the hardware list, the code will set up the drivers for all peripheral devices for the computer. The flash EPROM provides space for adding the code for any driver in order to properly operate the invented secure boot for the computer.

For classic drivers like parallel-serial port, USB, Keyboard, Floppy Disk, IDE, SCSI, CD-ROM, VGA, the code is implemented as part of the standard kernel. Each driver is allocated a specific address in to burn into the flash memory using the auto burning process of the smart card.

The flow chart shown in FIG. 8 explains the process of registering drivers for all peripherals inside the kernel.

After the security kernel has been loaded to the secure memory area, the entire main memory map is as shown in FIG. 7.

Creation of the Digital Signature

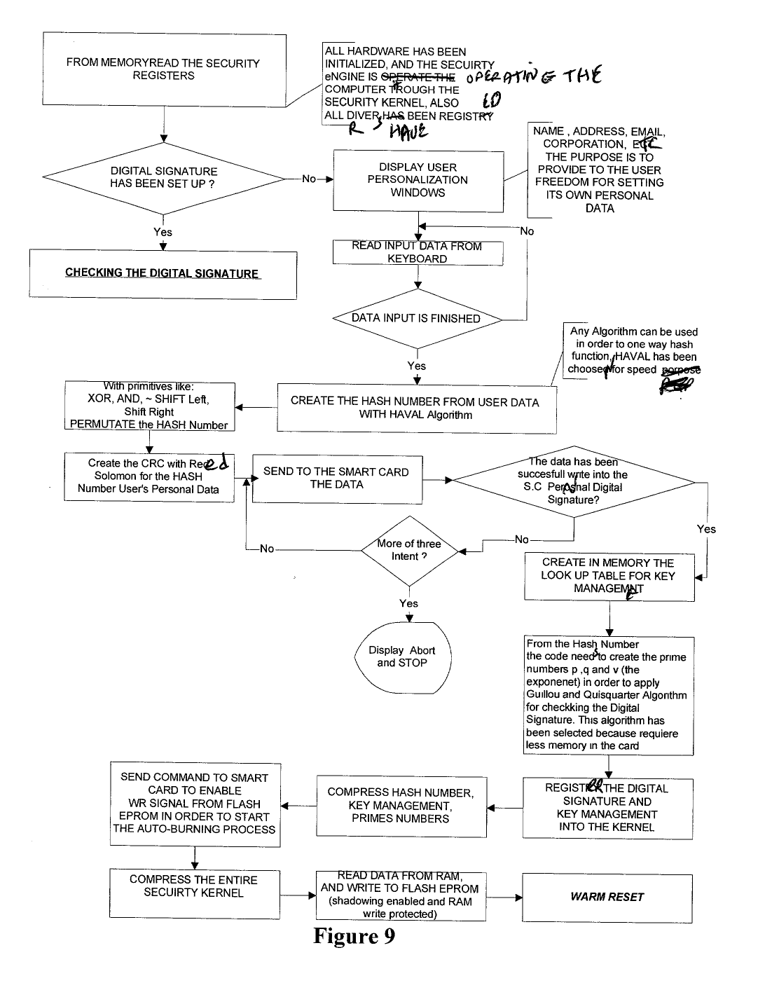

After the security kernel is in place in RAM, the code will check if the computer has been “Personalized” (Creation of the Digital Signature). FIG. 9 explains this process.

Checking Digital Signature

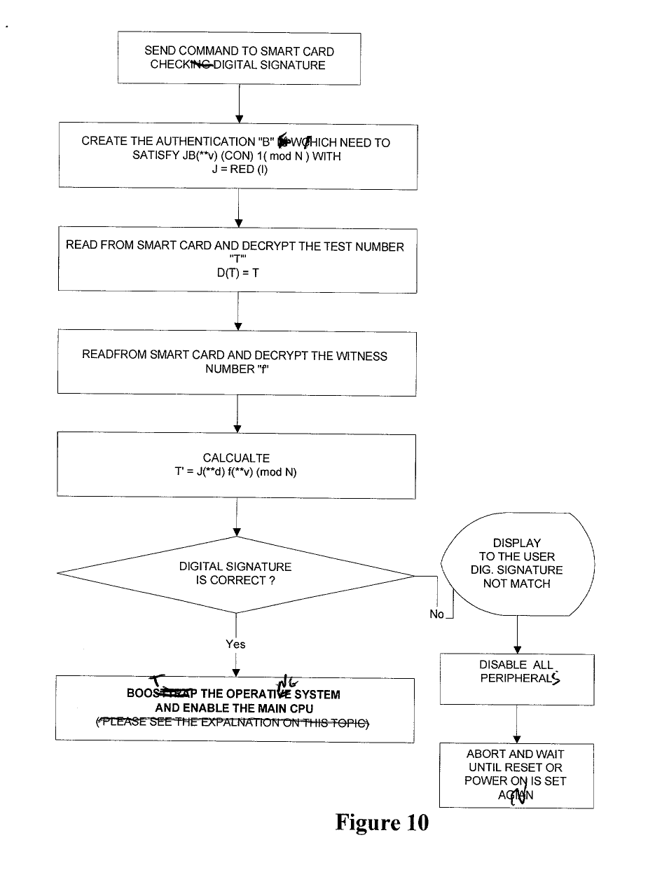

Referring now to FIG. 10, every time the computer is powered on or a cold-warm reset has been performed, the security kernel will check the digital signature. The algorithm used is Guillou-Quisquarter. This algorithm has been modified from the original “Zero Knowledge Protocol”, because both verifiers (security kernel and smart card) independently calculate the authentication number. This is done because security is one of the major goals in this invention. After the checking the digital signature., if both numbers T and T′ do not match, the security kernel will disable all peripherals and communicate this event via a display. The system will go into a loop, waiting for a reset or power-on after which it starts again with the checking. No boot operation can be done in any way using the hard disk drive or floppy disk drive since such devices are not enabled.

One reason for choosing this algorithm is because it tries to keep the size of each accreditation (i.e. each round) to a minimum. On the another hand, it does require about 3 times the computational power of other algorithms. This increase in required computational power will be of minimal importance given the increasing speed of processors in modern systems. One of the crucial points in the selection of the algorithm is the speed in which the digital signature is checked between the smart card and the security kernel. More complex algorithms will delay the booting process for the computer. That is, every time the computer is turned on or a cold reset is performed, the invention will check the digital signature automatically. If the algorithm used to check the digital signature requires more computational power, the time for checking the digital signature will increase due to complexity of the algorithm, and the time for booting the computer will increase.

All transaction checking and creation of the digital signature is done in memory in the security area.

Boot Operating System

Once the power-on self test (POST) is terminated, the security kernel has been loaded in RAM, and the digital signature has been checked. Two tasks remain to be completed Initialization of the main CPU and boot of the operating system

All the events described above have been done with the security engine. The main CPU is disabled (HOLD is asserted on the Reset Line), and the PCI bus is also disabled from the modified north bridge.

In a standard system, BIOS ROM is accessible to the microprocessor just below the fourth gigabyte memory address region immediately after a system power-on or after a hard reset to the microprocessor occurs. This is because address lines A20 through A31 in an Intel or similar 32 bit microprocessor are driven high for code fetches immediately after one of these reset occurs. In addition, Intel and similar microprocessors set the 16 bit Instruction Pointer (IP) to a fixed starting value of FFF0h. This forces the CPU to fetch its first instruction from physical address FFFFFFF0h. During a hardware reset, the segment selector in the code segment (CS) register is loaded with F000h and the base address is loaded with FFFF0000h. When the microprocessor is placed in real-address mode, it begins executing software initialization code from physical address FFFFFFF0h.

How is the Main CPU initialized?

The main CPU after power on or reset, has a physical address that is always a constant. That is, the first instruction that is fetched and executed following a hardware rest is located at physical address FFFFFFF0h. This address in an Intel or similar processor always is the same to ensure backward compatibility. The modified north bridge will acknowledge this event and will re-direct to the address for example JMP FAR F000:E05B. Once the first jump has been executed, the microprocessor is placed in the Real Address mode compatible with Intel 8086 microprocessor based IBM compatible PC AT computer series. The code segment CS register value after the first jump is FOOOh. The instruction pointer (IP) register value at this point is E05Bh.

In Real-Address-Mode, the only system data structure that must be loaded into memory is the IDT (also called “Interrupt Vector Table”). By default the address of the base of the IDT is physical address Oh. This interrupt table and data initialization data is done by the posting code from the security kernel when the main CPU was disabled.

During the main CPU initialization, the code will try to read the first sector of the first floppy disk: the boot sector. If this fails, the code tries to read the boot sector from the first hard disk. The booting of an operating system generally proceeds in several steps. As there is not much room for code in the boot sector, this normally loads a second loader, and so on, until the actual operating system kernel is completely loaded.

The following example shows the structure of a Master Boot Sector. Its length is always 512 bytes (so that it can be stored on either a floppy disk or a hard disk drive)

Offset

0x000 JMPXX

0x003 Disk parameters

0x03E Program code loading the DOS Kernel for example

0x1FE 0xAA55 Magic number for the Standard BIOS

In this case, the disk parameters are significant only for MS-DOS. It is important that the code starts at offset 0 and that the boot sector is terminated by “the magic number”. Booting from hard disk is slightly more difficult, because it is divided into partitions. The standard BIOS, however, knows nothing about this. It therefore loads, as it would do with a floppy disk, the first sector, which is called the Master Boot Record MBR.

The MBR must therefore have the same structure, that is, the code starts at offset 0, the magic number AA55h is found at offset 1Feh. At the end of the MBR, the partition table is stored. This always has four entries, a partition table entry consists of 16 bytes.

The structure of the Master boot sector and the extended partition table is as follows:

Offset Length

000h 1BEh Code Loading and starting the boot sector of the active partition

1BEh 10h Partition 1

1CEh 10h Partition 2

1DEh 10h Partition 3

1EEh 10h Partition 4

1FEh 10h AA55 (Magic Number)

The code in the MBR must only carry out the following operations:

Determine the active partition

Load the boot sector of the active partition, using this initialization Code

Jump into the boot sector at offset 0

The number of the bytes in the MBR is more than sufficient to do this because, as described above, each partition in principle contains a boot sector, and furthermore, the structure of any second hard disk which may be present is similar to that of the first disk.

According to the above explanation the main CPU will boot any operating system in a most secure way.

Modified North Bridge

In the modified north bridge shown in FIG. 11, state machines and logic from the standard north bridge are modified and circuit logic is added to provide the following:

Host bus controller 111 which is a state machine for the security engine which responds after power-on or reset, and disables the main CPU, the host bus, and the main processor cache.

High speed bridge controller 113 which is a logic interface to initialize the north bridge, security engine CPU and memory. This sequence of events occurs every time the computer is powered on or reset.

Security bus interface 127 which carries electronic signals for compatibility between main CPU and security engine in order to provide access to the main memory, or any device on the high or low speed bus.

Protection security kernel area 125 which provides lock circuit logic so that only the security engine can access the security kernel memory area.

Security bias interface 127 also includes a cache controller for the cache of the security engine

Security bus interface 127 also includes a circuit interface for data, address, and control of the security engine

Support concurrent main CPU, security engine, AGP, and PCI transactions in the main memory by elements 111, 117, 121, and 113.

Concurrent operations of the main CPU, PCI0, and PCI1/AGP, PCI2/security engine buses supported via dedicated arbitration and data buffering logic using elements 115, 127, and 121.

The modified north bridge isolates the main CPU from the host bus and the security engine CPU from the security bus. Also with the incorporation of more gates, the modified north bridge mates the main CPU and security engine CPU for read and write access to the system bus for interaction with I/O devices located in PCI slots, ISA slots, or peripherals coupled to parallel-serial port, USB, PS/2, micro channel slots, etc.

Addressing the security engine can be done in many way and is system dependent. This means that is not mandatory to specify how data and code can be shared between the operating system and the security kernel. One solution is to utilize peer host/PCI topology because the security engine cannot be added via PCI slots without sacrificing security. The security kernel (during the POST code procedure) must be designed to contain the proper configuration software support for this type of implementation. While initializing each peer host/PCI bridge, the security kernel must divide the system resources between the peer host/PCI bridge.

This approach is used because it provides a higher performance gain over a comparable PCI/PCI bridge implementation. The performance gain is the result of the parallel operation of the peer host/PCI bridges. The extra delay of a transaction passing through a second (or third) bridge is avoided. With this topology, a true real time encryption system can be implemented. For example, in online applications, a socket layer from the operating system datagram can be extracted and sent to the security bus for encrypt/decrypt functions.

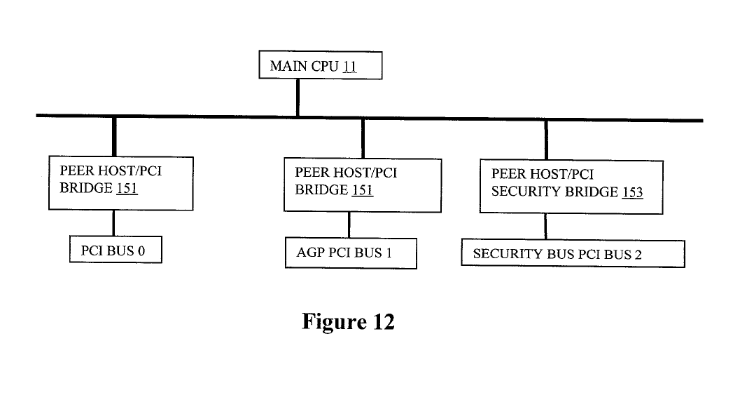

FIG. 12 shows the topology discussed above:

Since one of the peer host/PCI bridges 151 must be assigned a bus number value 00 after a hardware reset or power on, as shown in the block diagram for the modified north bridge, FIG. 8, the logic circuits allow the peer host/PCI security bridge 153 to start the security engine initialization process and gain control of the hardware. At this time, the host bus and main CPU cache, will be disabled in order to prevent any conflict from occurring.

Components related to the following functions have not been modified from a standard north bridge:

Processor/Host Bus Support

Integrated DRAM Controller: refresh mechanism: CAS-before RAS only supported, self-refresh

Support for DIMM Serial PD (Presence Detect)

PCI bus Interface: PCI Rev 2.2, 2.1, 33 MHz interface compliant

Asynchronous coupling to the host bus/core frequency

PCI parity generation support

Main CPU write assembly of full/partial line writes

Combines back to back sequential CPU to PCI memory writes to PCI burst writes

Data streaming support PCI to DRAM

Delayed transactions support

AGP interface

Power management functions

Smart Card

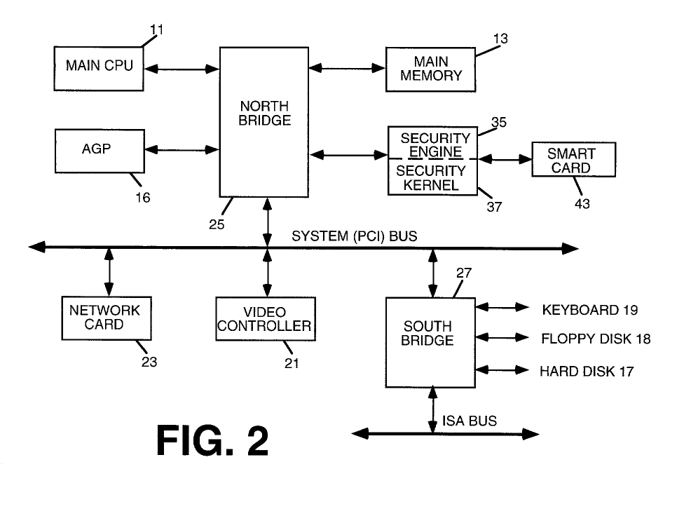

The smart card 43 (FIG. 2) has the responsibility of matching and creating the digital signature in conjunction with the security engine. This allows the use of any algorithm for the creation of digital signature, key generation, communication, and matching security folders. The smart card may be implemented using the following components: CPU, EEPROM, ROM, Clock, Reset Line, Internal RAM, Interrupt, and digital input/output as set forth below. In a preferred embodiment, at least three digital inputs/outputs are needed.

ROM: Read Only Memory stores the code of the Auto Burning process, digital signature creation-checking algorithms, Reed Solomon or CRC, Key Generation, communication code between the security kernel and the token card, and the set of commands between the security kernel and the smart card.

EEPROM: This is used for data storage such as the User's Digital Signature Encryption Keys, Digital Signature, checking inside of the security folders, and allocation file for the Security Folders.

Reset Line: This is an external line controlled by digital input/output from the security engine. This line is used in case there are some errors in checking the digital signature, or a time out has been taken place after the security engine sent a command and no response has been detected.

CPU: Central Processing Unit: this part will execute the code that has been written in the ROM and also execute the interrupt handler.

Clock: an oscillator for the execution and operation of the CPU

Internal RAM: used for global and temporary variables that the code requires.

Digital inputs/outputs:

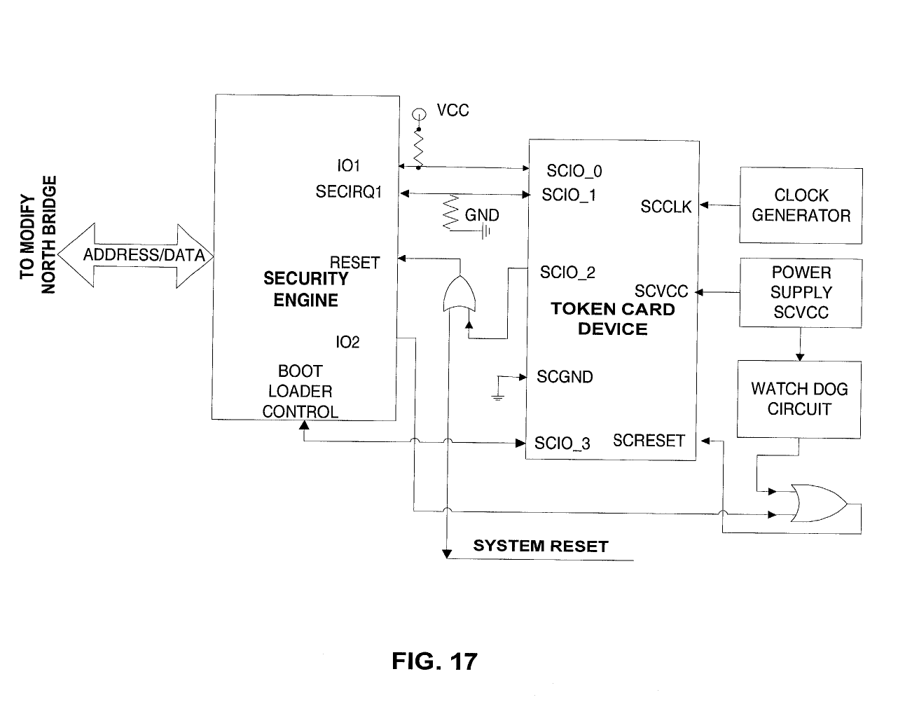

SCIO_{—}0 is used for data between the security engine and smart card; this line will be connected to IO1 security engine shown in FIG. 3a. and FIG. 17.

SCIO_{—}1 is used to address any IRQ line from the security engine (SECIRQ1 FIG. 3a); this line will interrupt the kernel when the smart card has data available to send to the security engine.

SCIO_{—}2 from the smart card (FIG. 17) is connected to an “or” gate with the System Reset Line. This is used when after the auto burning process has been completed and the security engine needs to be reset.

SCIO_{—}3 from the smart card is connected to the security engine. It is used for controlling the Auto Burning process through the Boot Loader Control Line from the Security Engine (FIG. 3a) and FIG. 17.

IO2 from the security engine is connected to an “or” gate with the output of the Watch Dog Circuit that is used to monitor the VCC line from the smart card.

In one embodiment, the digital signature checking scheme uses the Guillou and Quisquater algorithm, the creation of the digital signature uses a Haval algorithm which is a variable-length one-way hash function.

The internal code in the smart card will have a set of commands in order to cover all the functions required by a personal computer system without BIOS. Also future commands can be implemented. The basic commands are:

Write: Write (address initial, address final, value . . . )

Read Read (address initial, address final, value . . . )

Create_Digital_Signature: parameters)

Check_Digital_Signature: (parameters)

Create_Security_Folders: parameters)

Check_Security_Folder: parameters)

Modify_Security_Folders (parameters)

The size of data exchange between the smart engine and smart card is 256,128, 64 or 48 bits depending on the nature of the command. This provides more freedom, and speed for the transaction of data between the security engine and the smart card. In order to protect the communication between the security engine and the smart card, the commands and the data will be encrypted. The Haval algorithm can be used for this task.

The smart card has three different kind of memories: RAM, ROM and flash. In one embodiment, the invention uses four or more digital IOs for the smart card in order to accomplish the security goals,. These digital IOs are used for data, for controlling the WE (write enable) from the flash memory used by the security engine when it is necessary to write the digital signature, encryption keys, or other parameters which require a write operation to the flash memory used by the security engine.

The flow diagram shown in FIG. 13 shows the power on and reset procedures. The smart card will initialize all the internal variables in the internal RAM from the smart card. These internal variables are reused by many procedures due to the limitations of internal RAM from the smart card.

If no digital signature is in place, the code will wait to receive a command from the security engine to “Set the Digital Signature.” If the digital signature has been set, the smart card will send a command to the security engine to check the digital signature. For checking the digital signature, the Guillou Quisquater algorithm is used. At this moment, an Identification (I) is applied using Reed Solomon (J=Red(I)) and the result is encrypted using the key for communication procedures (J=E(Red(I))), and sent to the security engine.

At this moment, the smart card will read an integer “d” calculated randomly from the security engine. This number needs to be 0<=d>=n. A random number “r” is calculated in the smart card and computes a test number T=r(**v)(mod n), where this test number is computed as the vth power modulo n (prime number generated when the digital signature is generated) of “r”. At this time, the smart card sends this number to the security engine.

After that, the smart card computes t≡rB(**d)(mod n) where t is the “Witness Number” and sends it to the security engine.

In order to verify the identification, the security engine will compute the following equation:

J(**d)(mod n)≡J(**d)(rB(**d))**v(mod n)

(JB(**v))**d*r(**v)(mod n)

T

The security engine will encrypt this number and will send to the smart card T′=E(T′). The smart card also will check if the security engine corresponds to this smart card, this means the code inside the card will verify that the digital signature from the security engine is the same as from the smart card. If the digital signatures do not match, the software will stop any transaction in between the smart card and the security engine. On the other hand, if the digital signatures do match, the smart card will enable the rest of the commands in order to continue with normal operation.

Creation of Digital Signature

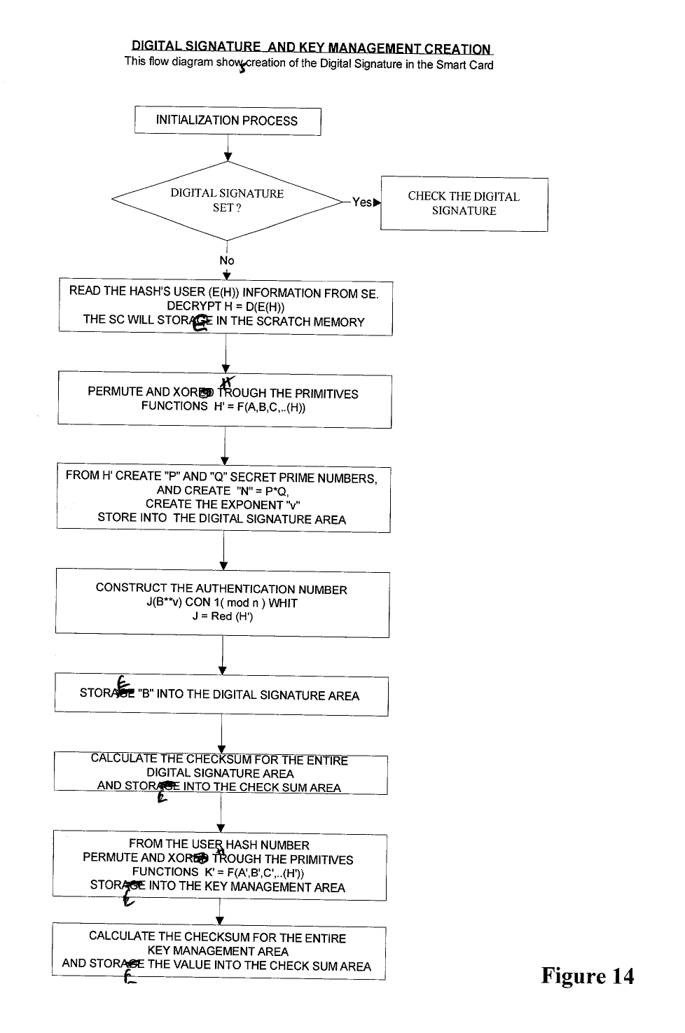

To create the digital signature, three components are involved, namely, the security kernel, the smart card, and the security engine. Referring to FIG. 14, the following description sets forth the required steps, according to events as they occur when the digital signature is used by the user.

The digital signature is shared in two places, one in the security kernel software and the other in the smart card software. The idea is to split the security data in two parts in order to have a strong level of security. Through this feature, a good key and digital signal recovery can be applied.

If the digital signature and the encryption key data from the smart card or the security kernel has been damaged, either the smart card or the security kernel can recover the data. The code will read the entire area containing the security data and calculate the check sum. If the check sum is different from previous calculations, the software will jump to a recovery process routine.

The code will detect if the digital signature has been set. If it is has not, the software will require that the digital signature be set. Any algorithm for checking the digital signature can be used. In one embodiment, a “Zero Knowledge” algorithm is used. This algorithm is used in both the smart card and the security engine. The idea is to provide a double-checking between the smart card and security kernel.

After the POST procedures have been completed (initialize memory, new bridges, extended BIOS for the add on cards, keyboard, video, etc), the security kernel checks to determine if the digital signature has been set up. If is has not, the security kernel will allow the user to create the digital signature. After the data has been input, the security kernel will create a hash number (H) from this data and send it encrypted to the smart card. The encryption key is pre-programmed and changed after the key has been created from the hash number (H′).

The hash (H) is permutated, XORed, according to primitive functions from the first 20 bytes from the hash (H), to create the hash (H′).

From the hash H′ a secret identification is created. In order to do this, prime numbers P and Q (around 256 bits long), the number N=P*Q, and an exponent v need to be created. All this numbers are stored in the digital area. After they have been created, the identification B is stored in the same memory area.

A check sum is applied in order to check the integrity of the data each time a power on or reset occurs. The result is written into the check sum area.

From the hash H, another permutation using an XOR operation is applied in order to create the key. In one embodiment, the encryption key is more than 2048 bits in order to allow any algorithm that needs to be implemented. The key is stored in the key management area. Another check sum is then calculated and stored into the check sum area.

Security Folders

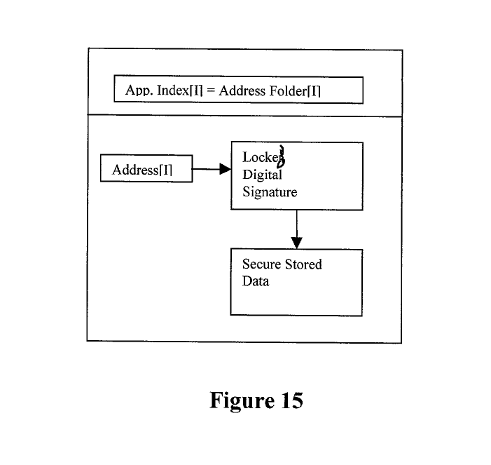

Security folders are composed of the following parts: Application Index, Address Folder, Locked Folder, and Secure Stored Data as shown in FIG. 15.

This invention provides an authentication form so that over a network, Internet, etc., any application can save its own secured and encrypted data into a security folder. Every application can set any kind of data and length. The data can also be encrypted by the host server with any algorithm. This provide freedom for any application to authenticate its own data. Another feature is to verify the contents from the data so the sever can receive the data and decrypt it without sending any key over the network. When the data is sent over the network, the security kernel will protect the data flow through a secure one time pad system (see one time pad description), for sending the data to a remote server.

For example, the user can register its own smart card to any application. The application (or remote server) will create a security folder for its own encrypted data and also with its own algorithm. When a new folder is created, the application will send an application index with a length of be 3 to 4 bytes. For the length for the security folder, the code from the smart card will assign a new address in the security folder area for this application. This address will be stored only in the smart card. After that, the remote server will store in a locked digital signature area the following data: parameters for digital signature, and application parameters. For the last part, the secure data will be stored. This data can be encrypted in any way with any key.

When the security kernel detects a remote server, it needs to verify a digital signature. To do this, it will send an encrypted command to the smart card, and request that the remote server verify a digital signature from a security folder. At this point, the security engine will send to the smart card the application index. The code in the smart card will check if this number has been issued and is correct. If this number is correct, the smart card will inform the security engine that it is ready to verify the locked digital signature. If the transaction is a success, the smart card will send the data to the security engine which will encrypt the data with a one time pad scheme and send it to the remote server.

Application Index:

Every application will have an index number of four bytes. This number is stored inside the smart card. This number will be public, and the remote server needs to verify or extract the information from the security folders, for its own application.

Locked Digital Signature

This block ensures the data, here a digital signature, is established with the remote server. In one embodiment, the encryption algorithm is DSA, however, any encryption algorithm can be used for this invention.

For this particular algorithm, the following parameters will be stored in this area:

p=a prime modulus

q=a prime divisor

g=h**(p−1) mod p, where h is any integer 1<h<p−1

x=a randomly or pseudo-randomly generated integer with 0<x<q

y=g**(x) modp

k=a randomly or pseudo-randomly generated integer with 0<k<q

The integer p, q, and g can be shared for the applicants that share the same remote computer. Parameters x and k private and public key, respectively and shall be kept in secret. The software in the smart card will allow to change the key at any time for the remote computer over the network. The generation of the prime numbers and parameters for this algorithm, can be created by the remote computer, and the data will be sent through the network and the operating system will inform the security engine, that secure data is available.

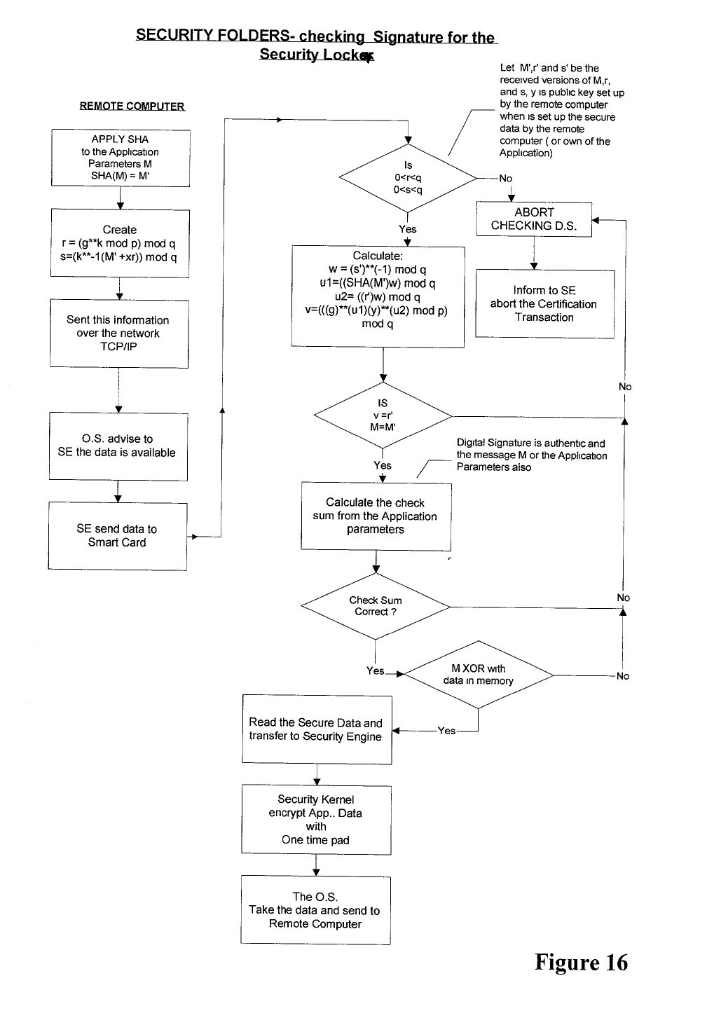

The flowchart of FIG. 16 shows how the remote server can request its own data in a secure manner.

The application parameters are composed of: data length, checksum, application identification. All this data constitutes the message M message in which a digital signature will need to be verified. For the message M, a hash algorithm will be applied. As an example DSA may be used, but any encryption algorithm can be used for this purpose.

When a remote server requires a transaction/verification for data, the source code from the smart card will require a digital signature verification. As an example, the algorithm used may be DSA. The flow diagram shows how the authentication of the remote server can be checked. If the signature does not match, the smart card will not send any data out and the task will be aborted. On the other hand, after the signature has been verified, the code will check application parameters, calculate the checksum and second will XOR the message received and decrypt with the data in non-volatile memory from the smart card. If this XOR operation is equal to “0” it means:

The server computer owns the data from the security folder

The server is requesting the correct application index data. This is because the invention can allow one remote server to have data stored for different application.

It is safe to disclose the data and send it to the security engine in which this data will be encrypted with the one time pad algorithm.

Example applications of the present invention as described above include:

Real Time Digital Signature Authentication scheme over a Network

A digital signature from any application can be stored inside the security folders of the smart card which can also be checked over the network in real time.

Secure and Personalized Software installation

The security kernel can install any application software over the network (Internet), CD-ROM, etc. A software manufacturer can register its own digital signature inside the security folders (inside the smart card) and from this can create installation software which can use the digital signature to decrypt the software to be installed into the computer.

Real Time Encryption over a Network

This invention provide the capability of checking in real time digital signature over a network using for example TCP/IP protocol. Two computers are connected over the network can exchange encrypted information without having a pre-stored encryption key. The security kernel includes code for encrypting/decrypting data in real time. The key management procedures create an encryption key for each transaction.

Although the invention has been described with reference to particular hardware and operating system environments, as utilizes in some cases well known algorithms, the invention is not intended to be limited to those specific elements disclosed which are provided by way of example implementations, and should be only be construed as defined in the following claims.

We claim:

1 A system for securely booting a computer including a main central processing unit, main random access memory, peripheral devices controllers and a bus coupled to said peripheral devices controllers, said system comprising:
a) a memory controller hub coupled to said central processing unit, said random access memory and said bus;
b) a security engine including a security kernel stored in a second memory coupled to said memory controller;
c) a smart card coupled to said security engine.

2 The system defined by claim 1 wherein the security engine comprises:
a) a central processing unit bus controller interface coupled to the memory controller hub;
b) a security engine processor coupled to the central processing unit bus controller interface;
c) an address decode unit coupled to the central processing unit bus controller interface;
d) a flash memory controller coupled to the address decode unit;
e) a flash memory coupled to the flash memory controller;
f) a general purpose bus controller coupled to the address decode unit;
g) a general purpose bus coupled to the general purpose bus controller;
h) a programmable input/output controller coupled to the general purpose bus;
i) programmable interrupt controller coupled to the general purpose bus.

3 The system defined by claim 2 wherein the memory controller hub comprises:
a) a host bus controller coupled to the main central processing unit through a security bus interface;
b) a high speed bridge controller coupled to the host bus controller, the security engine processor and main random access memory;
c) a security kernel memory area which includes lock circuit logic which operates so that only the security engine can access the security kernel memory area;
d) logic to support concurrent main central processing unit, security engine, and bus transactions in the main random access memory, and concurrent operations of the main central processing unit and security engine buses.

4 The system defined by claim 1 wherein the smart card comprises:
a) a central processing unit;
b) a read only memory storing code for auto burning electrically erasable read only memory, digital signature creation and checking, cyclical redundancy checking, key generation and communications;
c) an electrically erasable read only memory for storing a user's digital signature and encryption keys,
d) digital inputs/outputs for controlling auto burning, address IRQ lines from the security engine and communications between the security engine and the smart card.

5 The system defined by claim 1 wherein the security kernel comprises software which when executed by the security engine central processing unit:
a) initializes the memory hub controller;
b) disables the main central processing unit;
c) partitions the main random access memory;
d) creates and checks digital signatures;
e) interfaces with the smart card.

6 The system defined by claim 1 wherein said security engine further comprises a one time pad system to enable secure communications over unsecured connections.

7 The system defined by claim 6 wherein said one time pad system uses a single key to encrypt/decrypt messages and communication between parties over an unsecured connection is terminated, the security kernel operates to destroy all the data concerning the key.

8 The system defined by claim 7 wherein to create a key for the one time pad system, each of the parties involved in the communication generates a seed for a true random number generator, each of which seeds is used in order to create a random key.

9 The system defined by claim 8 wherein prior to initiation of a unrestricted communication between at least two computers, each computer checks a digital signature of each other computer using an arbiter computer to start and finish sending credentials and the security kernel of each computer independently checks the digital signature of the other computers and if the digital signature of any one computer fails, communication between each of computers is prevented.

10 The system defined by claim 1 wherein said security kernel is configured to allow a kernel of a second operating system to reside in the main random access memory concurrently with said security kernel.

11 The system defined by claim 1 wherein security kernel provides an interrupt vector to the main central processing unit after a digital signature has been verified to enable the main central processing unit to boot an operating system.

12 The system defined by claim 2 wherein the security kernel is configured to allow loading of a driver for any peripheral device during a booting process into said flash memory.

13 The system defined by claim 1 wherein the security kernel is loaded to a secure memory area within said main random access memory, such that a memory map of said main random access memory map includes within said secure memory area a security kernel interrupt vector table, a security kernel stack, a security kernel data segment.

14 The system defined by claim 1 wherein said main central processing unit is disabled until completion of a boot procedure by said security engine and said main random access memory is partitioned to provide an interrupt table for the main central processing unit and a second interrupt table for said security kernel.

15 The system defined by claim 1 wherein said security kernel is configured to create and check a digital signature to enable said secure boot of said computer.

16 The system defined by claim 4 wherein said auto burning configures a flash memory to store keys to provide security for peripheral device controllers.

17 The system defined by claim 1 wherein after the computer has been personalized for a particular user, the security kernel selectively connects the computer to a remote server, download an operating system and install necessary drivers.

18 The system defined by claim 3 wherein the host bus controller includes a state machine which is configured to disable the main central processing unit and said host bus after a cold or warm restart.

19 The system defined by claim 1 said security engine includes a peer host/PCI security to start security engine initialization after a hardware reset or power on and disable a host bus and main central processing unit cache.

20 The system defined by claim 1 wherein said smart card operates to create security folders within which any application can store its own encrypted data representing credentials of a user of the application.

21 The system defined by claim 1 wherein said smart card includes logic for verifying a digital signature over a network.

22 The system defined by claim 20 wherein said smart card includes a locked digital signature to protect and secure the data stored into the folders.

23 A method for securely booting a computer including a main central processing unit, main random access memory, peripheral devices controllers and a bus coupled said peripheral devices controllers, said method comprising the steps of:
a) sending a command to initiate a verification for a digital signature;
b) attempting to verify said digital signature using a predetermined algorithm;
c) if said digital signature is verified, enabling a main central processing unit and allowing a boot of an operating system;
d) if said digital signature is not verified, display a predetermined message and disable said peripheral device controllers.

24 The method defined by claim 23 wherein during said attempting to verify step, a smart card and a security kernel independently calculate an authentication number based on said digital signature previously stored in separate secure memory areas during an initialization process.
